(19) United States
(12) Patent Application Publication
(10) Pub. No.: US 2026/0039007 A1
(43) Pub. Date: Feb. 5, 2026

(54) MAST ATTACHMENT FOR AUTOMATIC ANTENNA BORESIGHT

(71) Applicant: ETS-Lindgren Inc., Cedar Park, TX (US)

(72) Inventors: Zhong CHEN, Cedar Park, TX (US); Garret MCKERRICHER, Austin, TX (US); Nicholas MOLENHOUSE, New Lenox, IL (US); Timothy TOBIAS, Caledonia, MI (US); Harris SPUNGEN, Grand Rapids, MI (US); Grant LUBBERT, Watervliet, MI (US)

(21) Appl. No.: 19/283,666

(22) Filed: Jul. 29, 2025

Related U.S. Application Data
(60) Provisional application No. 63/677,728, filed on Jul. 31, 2024.

(51) Int. Cl. H01Q 1/12; H01Q 3/02

(52) U.S. Cl. CPC H01Q 1/1242; H01Q 3/02

(57) ABSTRACT

Non-boresight mast converter systems and components are provided to convert a non-boresight mast configuration to a boresight mast configuration for automatic angular adjustment of a boresight of an antenna. In some embodiments, a mast converter system includes an automatic boresight attachment configured to cause angular rotation of a boresight of an antenna mounted to the automatic boresight attachment, the automatic boresight attachment being removably affixed to a mounting structure of the non-boresight mast configuration, the mounting structure configured to move up and down on a mast of the non-boresight mast configuration.

### CROSS-REFERENCE TO RELATED APPLICATIONS

This application claims priority to U.S. Provisional Application No. 63/677,728, filed Jul. 31, 2024, entitled “MAST ATTACHMENT FOR AUTOMATIC ANTENNA BORESIGHT,” the entireties of both of which are incorporated herein by reference.

### TECHNICAL FIELD

This disclosure relates to a method and system for adjusting an antenna boresight.

### BACKGROUND

Compliance of an item of electronic equipment with Electromagnetic Compatibility (EMC) standards, such as ANSI C63.4 (measurements>1 GHz) and CISPR 16-1-4, may be verified by electromagnetic testing. One example configuration for EMC standards compliance verification is shown in FIG. 1. FIG. 1 is a boresight configuration. Equipment under test (EUT) 2 is placed on an equipment platform 4 and an antenna 6 that is a known distance away from the EUT 2 may be aimed at the EUT 2. The antenna 6 may be placed on a mast 8 that extends from a mast platform 10 on or near a floor 12 of a test chamber 14 or facility. In some applications, the test configuration may be outdoors. To obtain a line of sight between the antenna boresight direction of the antenna 6 and the EUT 2, the antenna 6 may be configured to rotate through an elevation angle 16. In some configurations, the height 18 of the antenna 6 on the mast 8 may be adjusted, as well.

FIG. 2 shows a non-boresight configuration. The non-boresight configuration of FIG. 2 does not provide line of sight along the boresight of the antenna 6 toward the EUT 2 for all heights of the antenna 6. FIG. 3 is a perspective view of an example non-boresight configuration. In this example, a horizontal mounting structure 20 enables mounting of an antenna.

While boresight masts as shown in FIG. 1 are commercially available, they are mechanically complex and expensive compared to non-boresight masts. Conversely, a non-boresight mast is unusable in test applications where non-horizontal line of sight between the antenna 6 and the EUT 2 is required.

### SUMMARY

Some embodiments advantageously provide a method and system for adjusting an antenna boresight of an antenna affixed to a mounting structure that moves up and down the non-boresight mast in order to position the antenna at a height above the ground. A boresight device assembly may be removably affixed to the mounting structure and may include or be affixed to the antenna. The boresight device assembly includes a motor that may be controlled by a microcontroller to control the elevation angle of the antenna. The microcontroller may be positioned in or near the boresight device assembly or on or near a base or platform of the non-boresight mast configuration. In some embodiments, a height sensor detects a height of the antenna above the mast platform or the floor upon which the mast platform rests. In some embodiments, the height sensor may be a laser sensor or a draw wire sensor. The microcontroller may use the height detected by the height sensor for determining an angle through which the antenna is to be stepped to achieve or maintain a line-of-sight antenna boresight direction to the equipment under test (EUT). Embodiments enable modification of an existing traditional mast to have boresight capability when needed or desired.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 illustrates a boresight configuration;

FIG. 2 illustrates a non-boresight configuration;

FIG. 3 illustrates a non-boresight mast configuration;

FIG. 4 illustrates one example embodiment of a non-boresight mast converter system according to principles disclosed herein;

FIG. 5 illustrates one example embodiment of a non-boresight mast converter system according to principles disclosed herein;

FIG. 6 illustrates one example embodiment of a non-boresight mast converter system according to principles disclosed herein;

FIG. 7 illustrates one example embodiment of a non-boresight mast converter system according to principles disclosed herein;

FIG. 8 illustrates one example configuration of an automatic boresight attachment according to principles disclosed herein;

FIG. 9 shows a variety of adapters that are available for affixing an antenna to a mounting structure;

FIG. 10 is a first perspective view of one example of an automatic boresight attachment according to principles disclosed herein;

FIG. 11 is a second perspective view of one example of an automatic boresight attachment according to principles disclosed herein;

FIG. 12 is another example of a non-boresight mast converter system that enables remote controllable polarization selection according to principles disclosed herein;

FIG. 13 illustrates a vertical polarization positioned by the non-boresight mast converter system; and

FIG. 14 illustrates a horizontal polarization positioned by the non-boresight mast converter system.

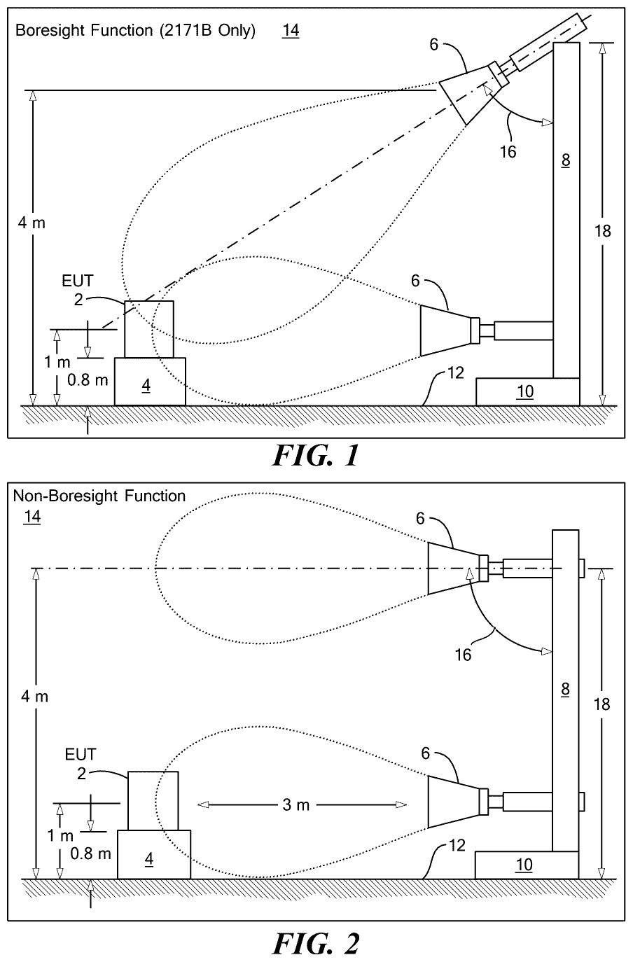

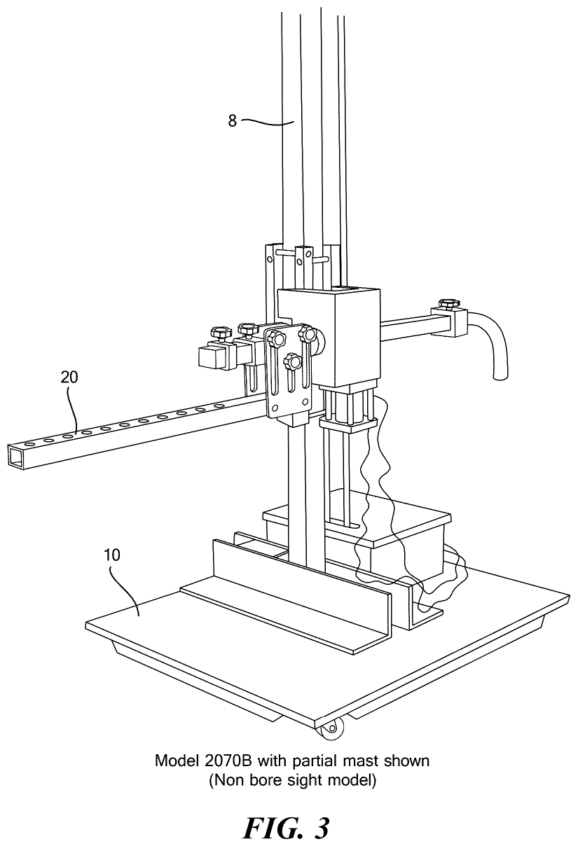

### DETAILED DESCRIPTION

Before describing in detail exemplary embodiments, it is noted that the embodiments reside primarily in combinations of apparatus components and processing steps related to adjusting an antenna boresight. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate, and modifications and variations are possible of achieving the electrical and data communication.

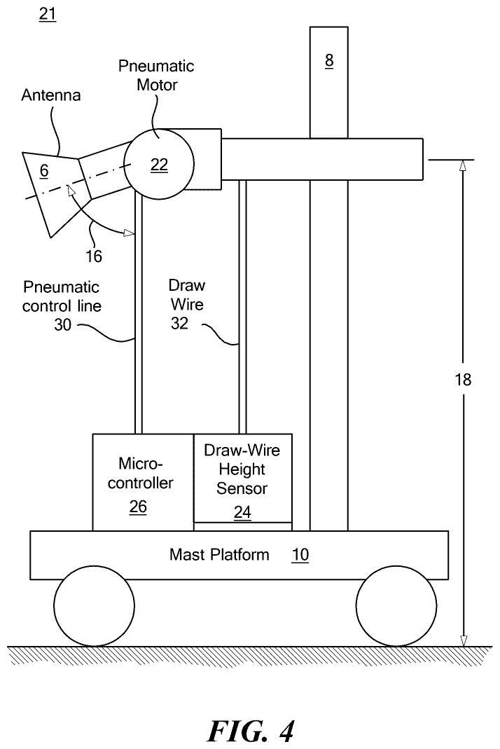

Some embodiments include a non-boresight mast converter system configured to convert a non-boresight mast configuration to a boresight mast configuration for automatic angular adjustment of a boresight of an antenna. Referring again to the drawing figures, in which like elements have like reference numerals, there is shown in FIG. 4, one example of a mast converter system 21 which includes a pneumatic motor 22, a draw wire height sensor 24 and a microcontroller 26. In the example of FIG. 4, the microcontroller 26 is located on a mast platform 10 and remotely drives the pneumatic motor 22 by way of a pneumatic control line 30. The draw wire height sensor 24 senses height by way of a draw wire 32 that that extends from the mast platform 10 to the height 18 of the antenna 6.

In some embodiments, the microcontroller 26 receives an electrical signal from the draw wire height sensor 24 which enables the microcontroller 26 to determine the height 18 of the antenna 6. The microcontroller 26 may also be configured to receive and/or compute a distance between the Antenna 6 and an EUT. Based at least in part on the height 18 of the antenna 6 and the distance between the Antenna 6 and the EUT, the microcontroller 26 may compute (predict) an angle 16 of the antenna 6 that would be required to aim the boresight of the antenna 6 to point along the line of sight between the antenna 6 and the EUT.

The microcontroller 26 may compute an angular difference between the predicted angle and an actual angle of the antenna 6. Based at least in part on this angular difference, the microcontroller 26 may develop a control signal to cause a valve, for example, to open and close to provide pulses of air to flow through the pneumatic control line 30 from a nearby air supply (not shown), such as a tank of compressed air located in a vicinity of the non-boresight mast configuration.

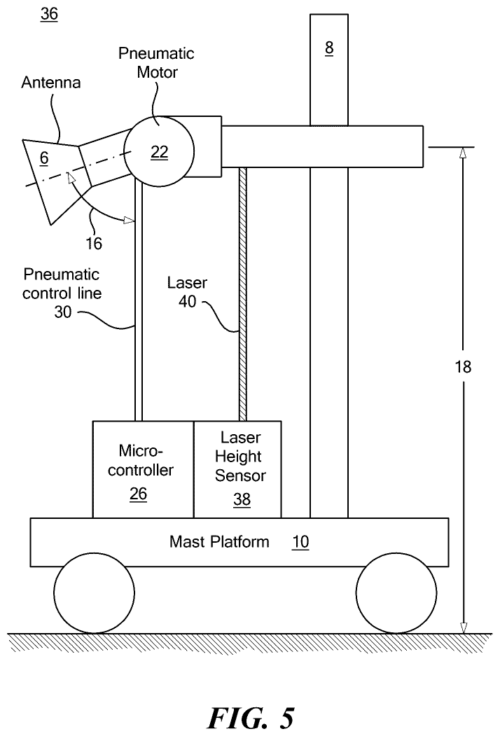

FIG. 5 is another example embodiment of a mast converter system 36 that has similar construction as the example embodiment of the mast converter system 21, but instead of the draw wire height sensor 24 and draw wire 32, there is a laser height sensor 38 that emits a laser beam 40. The microcontroller 26 may determine the height 18 based at least in part on a time of flight or phase change of the laser beam.

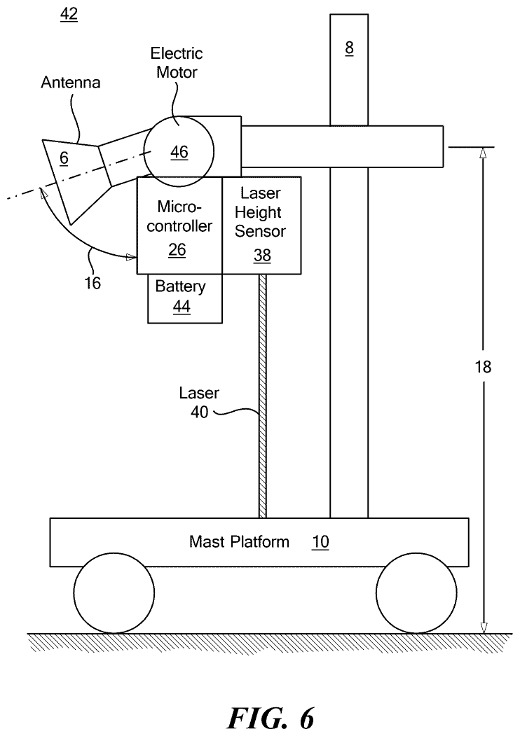

FIG. 6 is another example embodiment of a mast converter system 42 with a battery 44 and an electric motor 46 instead of the pneumatic motor 22. Also, FIG. 6 shows that the laser height sensor 38 and microcontroller 26 may be placed in proximity to the electric motor 46 and the battery 44. The microcontroller 26 may be configured to provide motor drive signals to the electric motor 46 which may be a step motor. In some embodiments, the motor drive signals causes the motor 46 to step through angular increments until the boresight direction of the antenna 6 coincides with the line of sight between the antenna 6 and the EUT 2.

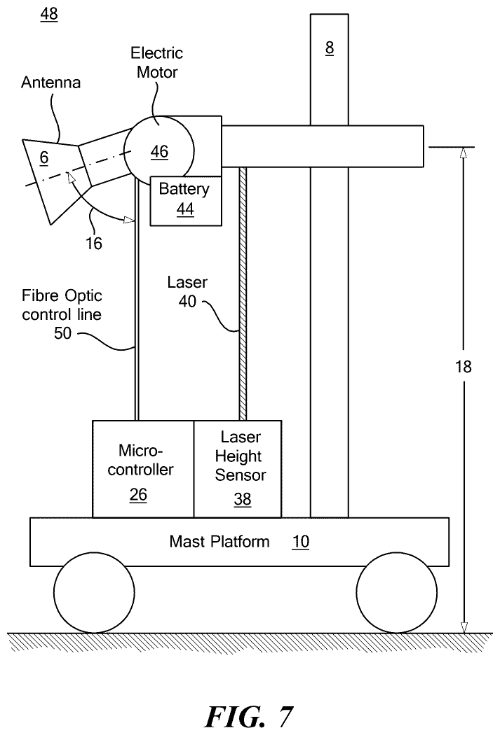

FIG. 7 is another example embodiment of a mast converter system 48 where the battery 44 and electric motor 46 are in proximity to the antenna 6 and the microcontroller 26 and laser height sensor 38 are on the mast platform 10. In FIG. 7, the motor drive signals from the microcontroller 26 may be communicated to the electric motor 46 by way of a fiber optic line 50, or other transmission line.

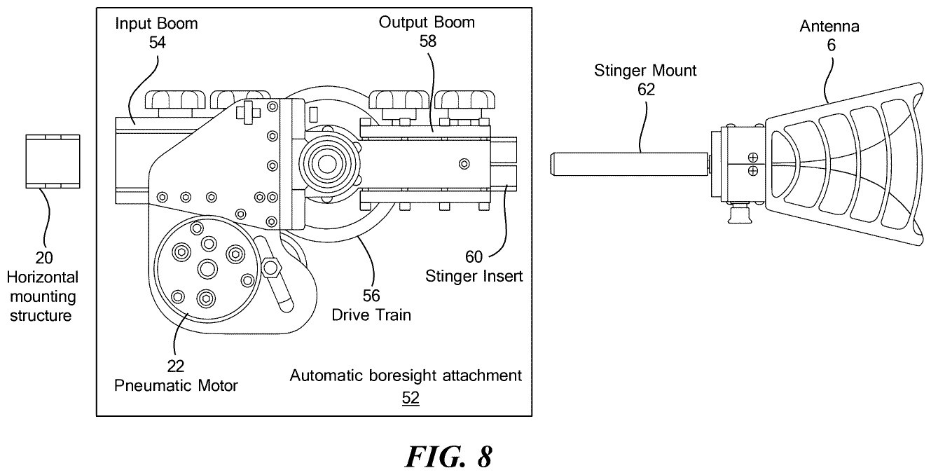

FIG. 8 is example of an automatic boresight attachment 52 configured to connect the horizontal mounting structure 20 and the antenna 6. In the example of FIG. 8, the automatic boresight attachment 52 includes a pneumatic motor 22 an input boom 54, a drive train 56 and an output boom 58. An insert 60 may be provided to receive a mount 62 of the antenna 6. The input boom may be configured to fit a standard 2 inch by 2 inch square tubing of the horizontal mounting structure 20. However, input boom may be configured to receive a horizontal mounting structure that is not square, for example, circular or triangle. This embodiment shows the output boom with a stinger insert which fits the antenna shown.

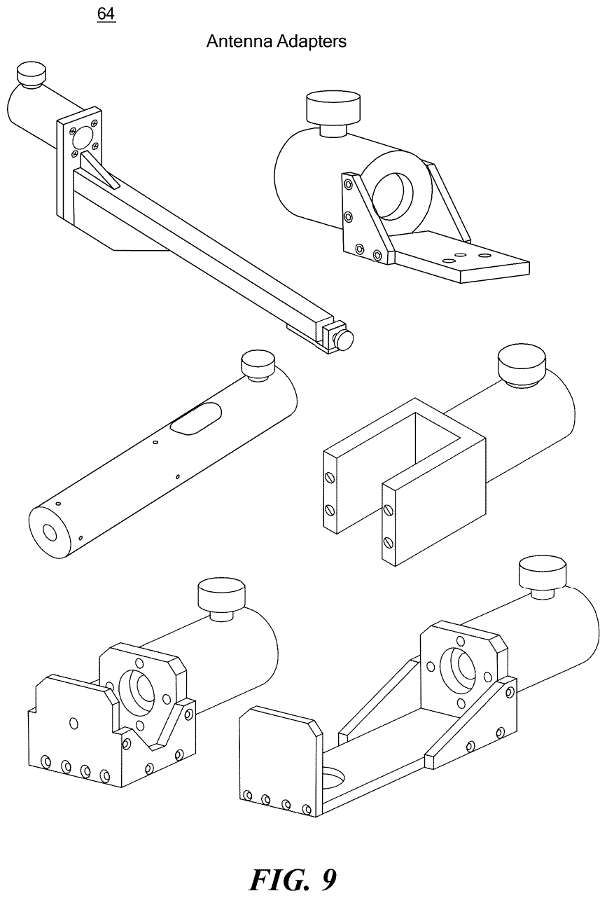

FIG. 9 shows a variety of adapters 64 that are available for affixing the antenna to a circular horizontal mounting structure 20. Adapters for affixing the antenna to a horizontal mounting structure 20 may be implemented or found on existing non-boresight mast configurations.

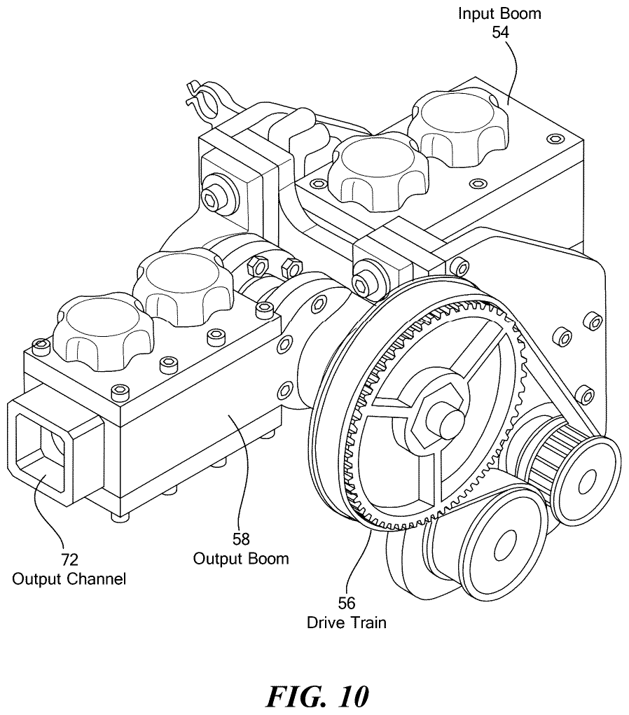

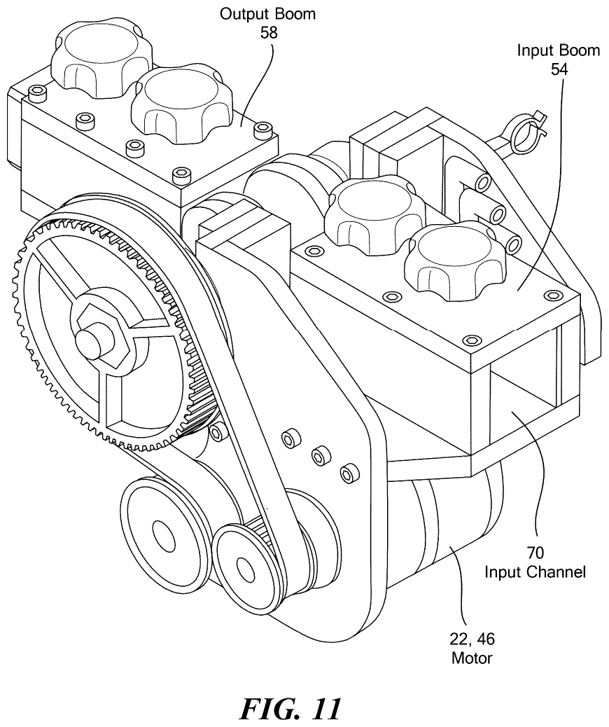

FIGS. 10 and 11 show perspective view of the automatic boresight attachment 52. As shown in FIGS. 10, the drive train 56 may include a rotation assembly which may include a gear assembly and/or a belt drive assembly. A motor 22, 46 may be housed in a housing drive train 56. The rotation assembly transfers rotation of the motor 22, 46 to rotation of the antenna 6. The antenna 6 may be mounted to the output boom 58. As the motor 22, 46 is caused to rotate by a pulse of air (in the case of the pneumatic motor 22) or an electrical signal (in the case of an electric motor 46), the antenna 6 is caused to rotate through a desired angular increment. In some embodiments, the drive train 56 may include belts and pulleys. The pulleys may include a drive pully, a pinion pulley and an idler pully. The pinion pulley may be mounted on an output shaft of the motor 22, 46. In some embodiments, the drive train 56 may include gears. The gears may include a drive gear, which may be mounted on a keyed shaft that uses a key for torque transmission and a set screw for horizontal stability.

The input boom 54 shown in FIG. 11 may include an input channel 70 configured to receive a horizontal mounting structure 20. The output boom 58 shown in FIG. 10 includes an output channel 72 configured to receive the mount 62 of antenna 6. The output channel 72 may be formed by two rectangular halves that clamp around the mount 62. Knobs 74 attached to set screws may be provided to secure the horizontal mounting structure 20 to the input boom 54. Knobs 76 attached to set screws may be provided to secure the mount 62 to the output boom 58.

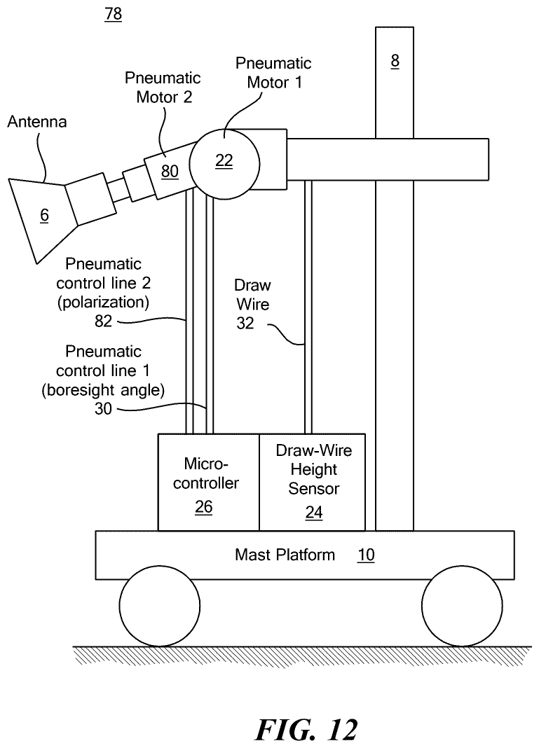

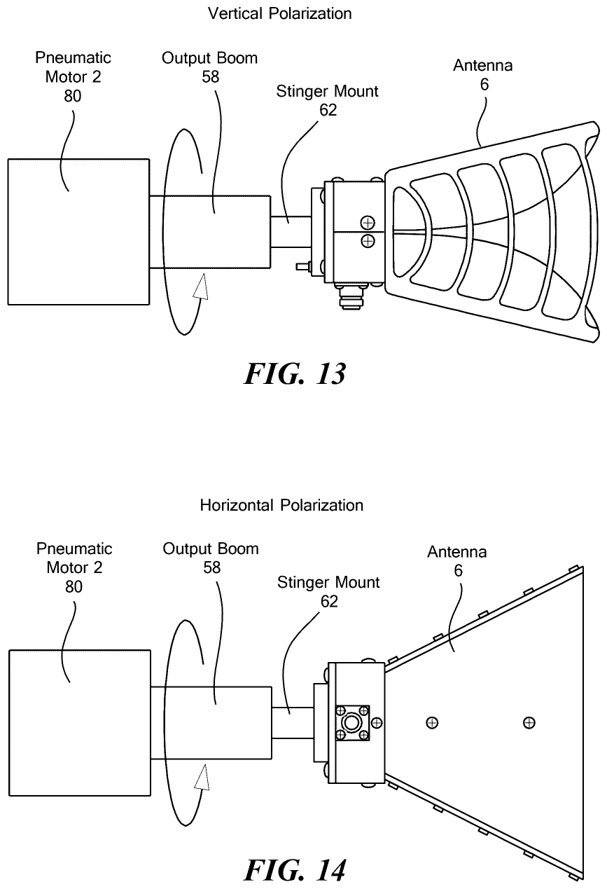

FIG. 12 is an example of a non-boresight mast converter system 78 configured to rotate the antenna 6 to change a direction of polarization of the electromagnetic field radiated by the antenna 6 from a first direction to a second direction by remote control, obviating a need to manually change the position of the antenna. The antenna 6 may be rotated by a second pneumatic motor 80 controlled by air pressure from a second pneumatic control line 82. The microcontroller 26 may control a second valve between a pressurized air reservoir and the second pneumatic control line 82 to cause one or more bursts or pulses of air to be conducted through the second pneumatic control line 82 to drive the second pneumatic motor 80. A side view of the antenna 6 positioned for radiating a vertically polarized electromagnetic field is shown in FIG. 13. A side view of the antenna 6 for radiating a horizontally polarized electromagnetic field is shown in FIG. 14. Either polarization may be obtained by causing the second pneumatic motor 80 to rotate. Note that in the alternative to providing the second pneumatic motor 80 to rotate the antenna 6, a pair of pistons and mechanical linkage may be provided to switch between two orthogonal polarizations. In the alternative to using a second pneumatic motor 80, a second electrical motor may be employed to change the polarization direction. In some embodiments, both the angular rotation of the antenna 6 in elevation and the rotation to change the direction of polarization may be achieved by a single motor and mechanical linkage.

According to one aspect, in some embodiments, a non-boresight mast converter system 21, 36, 42, 48, 78 is provided to convert a non-boresight mast configuration system to a boresight mast configuration for automatic angular adjustment of a boresight of an antenna 6. The mast converter system 21, 36, 42, 48, 78 includes an automatic boresight attachment 52 configured to cause angular rotation of a boresight of an antenna 6 mounted to the automatic boresight attachment 52, the automatic boresight attachment 52 being removably affixed to a mounting structure 20, of the non-boresight mast configuration, the mounting structure 20, configured to move up and down on a mast 8 of the non-boresight mast configuration. In some embodiments, the automatic boresight attachment 52 may be configured to include an input boom configured to removably affix the automatic boresight attachment 52 to the mounting structure 20. The automatic boresight attachment 52 is also configured to include an output boom configured to removably affix the automatic boresight attachment 52 to the antenna 6. A drive train 56 that includes a motor 22, 46 is configurable to convert an angular rotation of the motor 22, 46 to the angular rotation of the antenna boresight, the angular rotation of the antenna 6 being in a plane containing the mast 8 of the non-boresight mast configuration. In some embodiments, the mast converter system 21, 36, 42, 48, 78 includes a microcontroller 26 configured to generate a control signal to adjust the angular rotation of the antenna 6. In some embodiments, the motor is a pneumatic motor 22 and the control signal is configured to control a valve to send one or more pulses of air to the pneumatic motor 22. In some embodiments, the motor is an electric motor 46 and the control signal is an electrical signal configured to control the electric motor 46 to rotate through an angular increment. In some embodiments, the microcontroller 26 is located in proximity to a base 10 of the non-boresight mast configuration and the electric motor 46 is in signal communication with the microcontroller 26 via of a transmission line 50, which may carry signals at optical frequencies. In some embodiments, the microcontroller 26 is in proximity to the automatic boresight attachment 52. In some embodiments, the mast converter system 21, 36, 42, 48, 78 includes a height sensor 24, 38 to determine a height 18 of the antenna 6. In some embodiments, the height sensor includes a draw wire sensor 24 that includes a draw wire 32 extending from the draw wire sensor 24 to the height 18 of the antenna 6. In some embodiments, the height sensor includes a laser height sensor 38 located at a base 10 of the non-boresight mast configuration. In some embodiments, the height sensor 38 includes a laser sensor located in proximity to a height of the antenna 6. In some embodiments, the drive train 56 includes at least one of belts, pulleys and gears. In some embodiments, the automatic boresight attachment 52 includes a second pneumatic motor 80 configured to cause a change in a polarization direction of the antenna 6.

In some embodiments, as the antenna height 18 is stepped through a sequence of successively decreasing or increasing heights, the antenna angle 16 is correspondingly stepped through successive elevation angles to maintain a line of sight antenna boresight direction between the antenna 6 and the EUT 2.

In some embodiments, the microcontroller 26 may be a programmable processor with memory configured to store computer instructions executable by the processor to cause angular adjustment of the antenna when the height of the antenna is fixed or as the height of the antenna changes. Instead of a programmable processor, application specific integrated circuitry may be employed. The memory for storing computer instructions may be volatile or non-volatile, and may be read-only memory or read-writeable memory. The memory may be removable. The memory may be external to the microcontroller 26. The microcontroller 26 may be configured with an input/output (I/O) port for receiving computer instructions and/or input data and for sending information to another device such as a computer having a user interface.

Some embodiments may include one or more of the following:

Embodiment A1. A non-boresight mast converter system configured to convert a non-boresight mast configuration system to a boresight mast configuration for automatic angular adjustment of a boresight of an antenna, the mast converter system comprising:
an automatic boresight attachment configured to cause angular rotation of a boresight of an antenna mounted to the automatic boresight attachment, the automatic boresight attachment being removably affixed to a mounting structure of the non-boresight mast configuration, the mounting structure configured to move up and down on a mast of the non-boresight mast configuration, the boresight device assembly configured to include:
   an input boom configured to removably affix the automatic boresight attachment to the mounting structure of the non-boresight mast configuration;
an output boom configured to removably affix the automatic boresight attachment to the antenna; and
   a device drive train that includes a motor and is configurable to convert an angular rotation of the motor to the angular rotation of the antenna boresight, the angular rotation of the antenna being in a plane containing the mast of the non-boresight mast configuration.

Embodiment A2. The mast converter system of Embodiment A1, further comprising a microcontroller configured to generate a control signal to adjust the angular rotation of the antenna.

Embodiment A3. The mast converter system of Embodiment A2, wherein the motor is a pneumatic motor and the control signal is configured to control a valve to send one or more pulses of air to the pneumatic motor.

Embodiment A4. The mast converter system of Embodiment A2, wherein the motor is an electric motor and the control signal is an electrical signal configured to control the electric motor to rotate through an angular increment.

Embodiment A5. The mast converter system of Embodiment A4, wherein the microcontroller is located in proximity to a base of the non-boresight mast configuration and the stepping electric motor is in signal communication with the microcontroller via of a transmission line.

Embodiment A6. The mast converter system of Embodiment A2, wherein the microcontroller is in proximity to the automatic boresight attachment.

Embodiment A7. The mast converter system of Embodiment A1, further comprising a height sensor to determine a height of the antenna.

Embodiment A8. The mast converter system of Embodiment A7, wherein the height sensor includes a draw wire sensor that includes a draw wire extending from the draw wire sensor to the height of the antenna.

Embodiment A9. The mast converter system of Embodiment A7, wherein the height sensor includes a laser sensor located at a base of the non-boresight mast configuration.

Embodiment A10. The mast converter system of Embodiment A7, wherein the height sensor includes a laser sensor located in proximity to a height of the antenna.

Embodiment A11. The mast converter system of Embodiment A1, wherein the drive train includes at least one of belts, pulleys and gears.

Embodiment A12. The mast converter system of Embodiment A1, further comprising a second pneumatic motor configured to cause a change in a polarization direction of the antenna.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. A non-boresight mast converter system configured to convert a non-boresight mast configuration system to a boresight mast configuration for automatic angular adjustment of a boresight of an antenna, the mast converter system comprising:
an automatic boresight attachment configured to cause angular rotation of a boresight of an antenna mounted to the automatic boresight attachment, the automatic boresight attachment being removably affixed to a mounting structure of the non-boresight mast configuration, the mounting structure configured to move up and down on a mast of the non-boresight mast configuration, the boresight device assembly configured to include:
an input boom configured to removably affix the automatic boresight attachment to the mounting structure of the non-boresight mast configuration;
an output boom configured to removably affix the automatic boresight attachment to the antenna; and
a device drive train that includes a motor and is configurable to convert an angular rotation of the motor to the angular rotation of the antenna boresight, the angular rotation of the antenna being in a plane containing the mast of the non-boresight mast configuration.

2. The mast converter system of claim 1, further comprising a microcontroller configured to generate a control signal to adjust the angular rotation of the antenna.

3. The mast converter system of claim 2, wherein the motor is a pneumatic motor and the control signal is configured to control a valve to send one or more pulses of air to the pneumatic motor.

4. The mast converter system of claim 2, wherein the motor is an electric motor and the control signal is an electrical signal configured to control the electric motor to rotate through an angular increment.

5. The mast converter system of claim 4, wherein the microcontroller is located in proximity to a base of the non-boresight mast configuration and the stepping electric motor is in signal communication with the microcontroller via of a transmission line.

6. The mast converter system of claim 2, wherein the microcontroller is in proximity to the automatic boresight attachment.

7. The mast converter system of claim 1, further comprising a height sensor to determine a height of the antenna.

8. The mast converter system of claim 7, wherein the height sensor includes a draw wire sensor that includes a draw wire extending from the draw wire sensor to the height of the antenna.

9. The mast converter system of claim 7, wherein the height sensor includes a laser sensor located at a base of the non-boresight mast configuration.

10. The mast converter system of claim 7, wherein the height sensor includes a laser sensor located in proximity to a height of the antenna.

11. The mast converter system of claim 1, wherein the drive train includes at least one of belts, pulleys and gears.

12. The mast converter system of claim 1, further comprising a second pneumatic motor configured to cause a change in a polarization direction of the antenna.
